(19) United States
(12) Patent Application Publication
(10) Pub. No.: US 2002/0136510 A1
(43) Pub. Date: Sep. 26, 2002

(54) Hybrid cable with optical and electrical cores and hybrid cable arrangement

(76) Inventors: Edgar Heinz, Steinach (DE); Hans-Matthias Horn, Neustadt (DE); Frank Koschwitz, Roedental (DE); Helmut Nowsch, Coburg (DE); Michael J. Ott, Ebenhausen (DE)

Correspondence Address: CORNING CABLE SYSTEMS LLC, P O BOX 489, HICKORY, NC, 28603, US

(21) Appl. No.: 10/101,131

(22) Filed: Mar. 19, 2002

(30) Foreign Application Priority Data
Mar. 23, 2001 (DE) 101114285.4

(51) Int. Cl. G02B 6/44

(52) U.S. Cl. 385/101; 385/114

(57) ABSTRACT

A hybrid cable with optical fibers and metallic conductors has a cable jacket with a first slot (14) for reception of optical fibers (121, 122) as well as a second slot (24) for reception of the electrical conductors (221, 222). The parts (1, 2) of the cable jacket forming the slots are connected to one another with a crosspiece. The cable has a preferred bending line, which is formed by the symmetrical axis (4) of the cable. The cable is especially suited for optical signal transmission in combination with the transmission of electrical data signal or supply voltage.

The invention concerns a hybrid cable, which includes optical as well as electrical cores within a single cable jacket. A hybrid cable arrangement additionally includes a connecting element.

A hybrid cable of the type mentioned in the beginning is especially used for data processing, f.e. to make the connection between optical networks and a patch field. The high frequency data transmission occurs in an optical path over at least one optical core, the low frequency data transmission, which mostly encompasses control or simple signaling functions, over a metallic conductor. In this way it is possible, to identify an optical signal connection to be constructed over the patch field by means of the metallic conductor, f.e. by the lighting of a light diode, so that it can be safely connected. A multitude of additional applications can be possible, where electrical signals as well as optical signals are to be transmitted by a single cable. At the end, the cable is connectorized with one or more connectors. For this, a multitude of possible connector variations are available.

U.S. Pat. No. 5,917,977 shows a hybrid cable, which contains optical as well as electrical cores. The optical fibers are arranged centrally in the center of the cable and are surrounded by tension relief elements. This arrangement in turn is surrounded by electrical twisted-pair conductors. Finally, the cable arrangement is surrounded by a water-resistant tape and an armored tape and protected on the outside by a cable jacket.

The objective of the invention is to provide a hybrid cable as mentioned in the beginning, which on one hand can be simply manufactured and on the other hand can be easily connectorized, which has good optical and electrical transmission characteristics.

According to the invention, this objective is achieved with a hybrid cable according to the characteristics in patent claim 1.

The hybrid cable according to the invention shows a first slot for only the optical cores and a second slot for reception of the electrical cores, especially copper braided wires. Both slots are connected to each other by a crosspiece. At the crosspiece the slots can be separated from each other and be connectorized with a common or separate connector. Each of the slots contains at least two optical or metallic conductors, respectively. The slots are constructed in such a way, that many different connectorized connections in a patch field can be made by means of the cable in a highly flexible way.

For this purpose the number of the optical cores is equal to the number of the electrical cores. In this way a metallic conductor of an electrical core can be assigned to each optical core, in order to identify the desired optical core during connectorizing a new connection in the patch field by impression of an electrical signal on the metallic conductor. F.e., from the multitude of the optical cores provided by the cable, only the metallic conductor of one of the cores is impacted with the signal. When inserting this connector connected to the metallic conductor into the patch field, a light diode is activated.

In order to achieve the preferred bending direction, all optical and electrical cores are essentially contained within the preferred bending line of the jacket. Additionally the crosspiece runs within the preferred bending line. When bending the patch cable, all optical and electrical cores are stressed mechanically in the same way. For this purpose the bending line runs through the center of the optical and electrical cores, so that the mechanical stress of these cores is as low as possible. The attenuation of the optical cores is kept as low as possible.

The jacket of the cable has a symmetrical axis running across the longitudinal direction of the cable. The cross-section center of the optical and electrical cores is located essentially on this symmetrical axis. The inner diameter of the jacket is thus adjusted to the optical and electrical cores in such a way, that on one hand there is sufficient space for the cores to move during bending of the cable, and on the other hand the twisting together of the cores during bending is avoided, and thus all cores run as parallel as possible within the slots. It is also necessary, that the cross-section center of the cores runs within the symmetrical line. The symmetrical line is at the same time the preferred bending line of the cable.

In a sample, eight optical cores and eight metallic cores guiding electrical signals are present in the respective slots, which preferably run parallel to each other. The optical cores are optical fibers made of silicon glass or plastic, either in singlemode or multimode construction. They can be arranged loosely, but preferably they are connected with each other in fiber ribbons. The electrical cores can be conducted loosely. The slot for the fiber ribbons is smaller than the slot for the metallic conductors. Viewed along the symmetrical axis or the preferred bending line, respectively, the diameter of the slot for the optical cores is smaller than the diameter of the slot for the electrical cores. The cable is constructed symmetrically relative to the crosspiece.

The fiber ribbons are preferably surrounded by tension relief elements. Aramid yams or Kevlar yams are especially suitable for this purpose. Tensile forces produced during bending of the cable are intercepted and distributed evenly over the fiber ribbon. During processing of the cable, f.e. paying off a storage reel or subsequent connectorizing, the tensile forces affecting the cable are absorbed by the tension relief fibers and are kept away from the ribbon.

The electrical cores for this purpose are copper braided wires. The braided wire is preferably formed from seven cores which are stranded together in the same lay. The braided wire again is surrounded by a jacket. The outer measurements of the braided wire jacket are constructed relative to the inner measurements of the slot receiving these electrical cores in such a way, that all of the eight cores are situated parallel to each other and are not displaced during bending. The cover end of the cores running parallel to each other and being situated beside each other, agrees with the cross-section surface of the slot. In any case, the cross-section surface of the slot is only minimally larger than the cover end of the cores, in order to ensure sufficient movement. The cross-section of the slot receiving the optical cores is selected in such a way, that the cover end of the aramid or Kevlar yams surrounding the fiber ribbon agrees essentially with the cross-section surface of this slot.

The cable jacket is preferably constructed of flame-retardant polymer material (FRNC: Flame Retardant Non Corrosive). An FRNC polymer material contains no halogens, especially no chloride. For the manufacture of the cable, the cable jacket is extruded onto the fiber ribbon surrounded by tension relief elements and onto the parallel running electrical cores. For the sample, the outer cable jacket is manufactured at a temperature of approx. 170° C. The jacket of the copper braided wires is preferably made of a silicone polyimide copolymer. This material has a utilization temperature of up to 150° C. The usage of the polymer material mentioned for the outer cable jacket as well as for the jacket of the copper braided wires has the advantage, that a coalescing of the copper braided wires with each other or with the cable jacket is avoided during coextrusion of the outer cable jacket. In order to avoid a possible danger of coalescing, the parallel arrangement of the electrical cores can additionally be wound with a polymer tape. The cable jacket made of FRNC polymer material is then extruded over the polymer tape.

The outer cable jacket is formed for this purpose in such a way, that it shows a rounded segment inside at the side of the cross-piece connecting the two slots. The rounded part preferably forms a semi-circular inner and outer line. Connected to this viewed in the outer direction, is a longitudinal segment parallel to the symmetrical and preferred bending line with segments running parallel to each other with parallel inner and outer jacket surfaces. Finally, the outer side of the cable jacket on both sides is terminated by a rounded segment, which preferable shows a semi-circular line inside and outside in the cross-section. The inner cross-section semi-circle has a dimension on the side of the electrical cores, so that the outer surface of the jacket of a copper braided wire can be contained. In certain cases it has to be considered, that the copper braided wire arrangement has to be contained by a polymer tape, which is supposed to avoid coalescing during extrusion. On the side of the optical cores the rounded part is formed in such a way, that the optical fiber ribbon surrounded by the tension relief elements is being contained with very little play.

A hybrid cable arrangement including the cable and a connector is given in patent claim 12. An alternative hybrid cable arrangement with two connectors is given in patent claim 13.

The preferred application of the hybrid cable according to the invention lies in the area of data cables for the computer or telecommunications technology. In this area there is the requirement, to produce optical transmission line segments over a patch field. The optical cores serve for the transmission of high frequency optical signals. The electrical cores transmit data and/or supply voltage. In a sample an electrical core is assigned to an optical core, which are terminated with a common connector. The optical core can be identified by transmission of electrical energy and electrical signals. Of course it is also possible, to assign several optical cores to an electrical core or to use all or selected electrical cores for energy or data transmission independent from the optical cores. In this way individual or all electrical conductors can be used for data transmission. Therefore it is possible by combining both application cases, to supply electronic switches with supply voltage as well as data by means of the electrical conductors. A functional unit connected to the cable can be supplied with high frequency data by means of the optical fibers, where the electronically operated functional elements are simultaneously supplied with voltage and additional data for signal processing or control are being transmitted over the same cable.

The invention provides for at least two electrical and at least two optical cores. For a preferred construction, eight optical cores and eight electrical cores are provided. Basically the invention includes any number of more than two optical and electrical cores each.

Subsequently the invention is explained by the construction samples shown in the diagrams. Shown is:

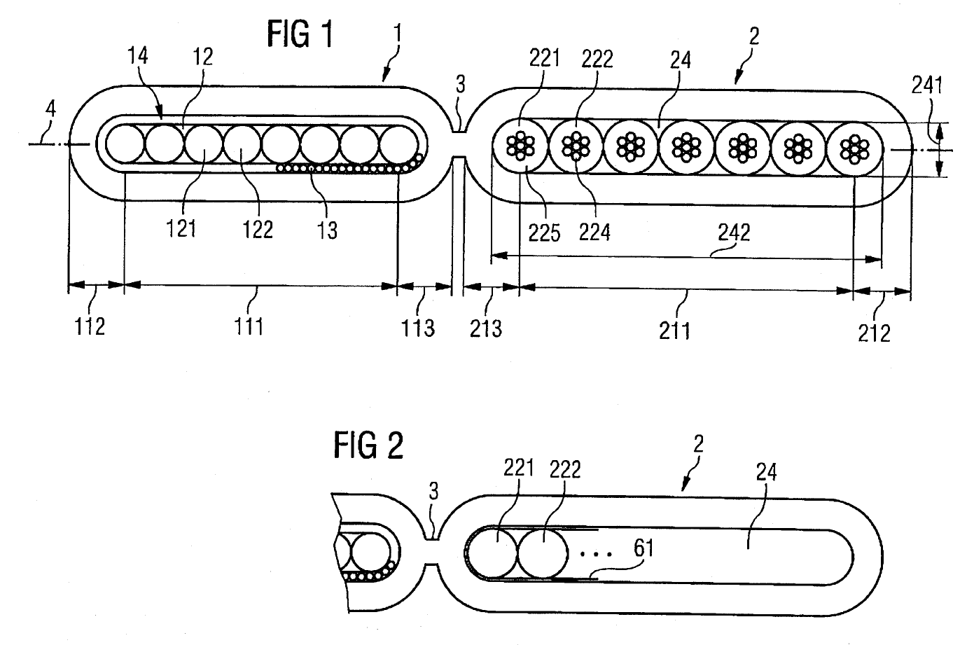

FIG. 1 a first construction sample of a hybrid cable according to the invention,

FIG. 2 a second construction sample of the slot containing the metallic conductors according to the invention,

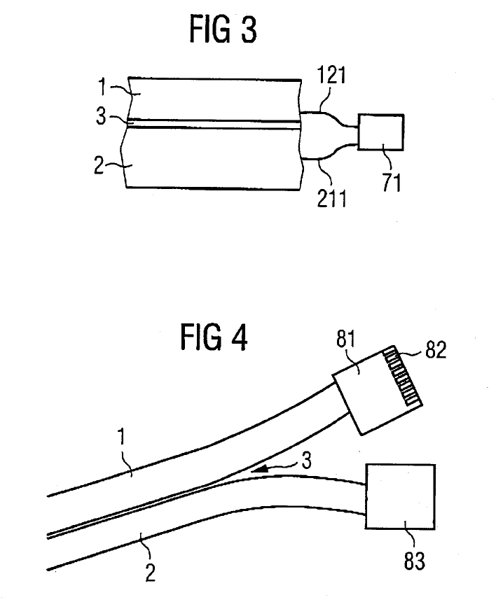

FIG. 3 a connectorized cable

FIG. 4 a cable with two connectors

The cable in FIG. 1 shows a cable jacket, which has a first part 1 for reception of optical cores, a second part 2 for reception of electrical conductors and a crosspiece 3 connecting the two parts 1, 2. The cable jacket is preferably made of flame-retardant material, so-called FRNC polymer material. The cable jacket forms the respective inner slots 14 for the optical cores and 24 for the reception of electrical conductors. The thickness of the cable jacket forming the slots is essentially constant viewed in the circumference direction. The crosspiece 3 connecting the two cable parts 1, 2 is constructed in thickness in such a way, that both jacket parts can easily be separated for the purpose of connectorization. The cable jacket is symmetrical relative to the symmetrical axis 4, which runs across the longitudinal elongation of the cable. The upper part of the jacket and the lower part of the jacket relative to the symmetrical axis 4 as shown in the diagram are axis symmetrical to each other to axis 4.

The slot 14 receives 8 optical cores as shown in the diagram, f.e. 121, 122. The optical cores are optical fibers for the transmission of optical signals. Glass fibers can be used for this; also possible are optical fibers made of plastic. All optical fibers are connected to each other in an optical fiber ribbon 12. This ensures that all fibers of the ribbon runs parallel to each other during bending of the cable, and do not strangle each other, whereby different cable attenuation could occur in a worst case scenario. The invention can also be used, if the optical fibers are not arranged as ribbons, but in loose form.

The optical fiber ribbon 12 is surrounded by tension relief elements 13. The tension relief elements are made of tension-proof fibers, f.e. aramid yarns or Kevlar yams. During cable processing tensile forces affect the cable f.e. during pay-off from a cable reel or during connectorizing of the cable, which are absorbed by the tension relief elements and thus are kept away from the optical fibers. The tension relief elements surround the optical fiber ribbon in the usual way. They run parallel to the optical fibers.

The second slot 24 contains eight metallic conductors as shown, f.e. 221, 222. The metallic conductors are electrical cores for transmission of data in the form of electrical signals or supplying energy. F.e. one of the cables can guide data, whereas the other cable transmits a supply voltage. The electrical conductors are preferably made of copper. In the construction sample shown, copper braided wires are being used. Each of the braided wires contain f.e. seven individual conductors, f.e. 224, which in turn are stranded together in the same lay. Each copper braided wire is separately surrounded by a cable jacket 225.

All optical cores are arranged parallel to each other in the cross-section shown, as are the electrical cores. The optical and electrical cores are also parallel to each other in the longitudinal direction of the cable. For the electrical cores it is possible to twist the cores with each other.

The electrical and optical cores each have a center point, which essentially lies on the symmetrical axis 4. In this way the cross-section of the electrical and optical cores mirror each other relative the symmetrical axis 4. This results in a preferred bending line for the cable, which runs along the symmetrical axis 4. The cable can be bent upward and downward around the symmetrical axis 4. All of the electrical and optical cores are thus only minimally stressed.

The inner measurements of the slots 14 and 24 are constructed in such a way, that the optical fiber ribbons on one hand together with the tension relief elements surrounding them, have a cross-section, which corresponds to the cross-section of inner slot 14, which is formed by the cable jacket. In the same way, the diameter of the electrical cores are approx. equal to the diameter 241 of the slot 24 formed by the cable jacket. The elongation of all eight electrical cores situated parallel to each other corresponds to the diameter 242 of the slot 24 seen along the symmetrical axis 4. The covering curve formed by the eight electrical cores corresponds therefore to the circumference of slot 24 formed by the cable jacket. Due to the dimension of the slots 14 and 24, determined by the electrical and optical cores to be received, the cores are held parallel to each other even during bending stress.

In the construction shown, the number of optical and electrical cores is equal. Since optical cores have a significantly smaller diameter than electrical cores, the elongation of the jacket part 1 along the symmetrical axis 4 is smaller than the corresponding elongation of the jacket part 2. Relative to the crosspiece 3 the cable construction is thus asymmetrical. It is essential that all components of the cable including jacket and electrical and optical cores are constructed essentially symmetrically to axis 4, in order to achieve good bending characteristics, but still have sufficient stability.

The two parts 1, 2 of the cable jacket have a first segment 113, 213, which is immediately adjacent to the crosspiece 3 and is formed as an arch. The preferred construction is a circular arch. Tangentially, the end of the arch 113, 213 transitions in upper and lower straight segments 111, 211. The segments run parallel to each other and parallel along the symmetrical axis 4. Finally, another arch-like segment, preferably a circular arch, follows tangentially at the outer ends of the straight segments 111, 211, so that an enclosed slot is formed.

The jacket of the cable is extruded. It consists of a flame-retardant material that contains no halogens, especially no PVC. During extrusion the melted polymer forming the cable jacket has a temperature of approx. 150° C. This avoids a coalescing of the polymer jackets of the electrical cores with the inside of the outer cable jacket 2.

In order to eliminate a remaining danger of the coalescing of the jackets of the electrical cores with the outer cable jacket, the parallel running arrangement of the electrical cores can be wound with a temperature stable polymer tape, as shown in FIG. 2. The jackets 225 of the copper braided wires are isolated by the polymer tape 61 from the inner side of the FRNC polymer material of the jacket 21 and do not show any contact surfaces. In this case the inner cross-section of the slot 24 is naturally minimally larger than in the construction sample in FIG. 1, so that the polymer tape can additionally be received into the slot 24. As shown in FIG. 2, the electrical cores can be single core conductors instead of the copper braided wires.

The cable according to the invention is especially advantageous when used as a hybrid patchcord cable for optical connections in a patch field. Several cables can be put on top of each other parallel to their symmetrical axis and can be connected to each other. The ends of the cables are connectorized. Many well-known and usual connectors can be used for this. It is especially advantageous, as shown in FIG. 3, when one of the optical cores 121 can be guided with one of the electrical cores 211 to a connector element, especially a connector 71, as a core pair. The optical core is identified by the electrical core. For a connection, f.e. only the electrical conductor 211 within all eight electrical cores contained in cable part 2, is activated. The optical core 121 to be identified is then characterized by interrogation of the electrical signal supplied by the electrical core 211.

A further hybrid cable arrangement is shown in FIG. 4, where the cable is connectorized by connector elements according to the invention. The cable is separated at the end along the crosspiece into one cable part containing the metallic conductors, and into another cable part containing the optical fibers. In this way, all eight metallic conductors and all eight optical fibers in the construction sample shown can be connectorized with one connector element 81 or 83, respectively, each. The connector 81 comprises connector elements, f.e. 82 for each of the electrical cores, which correspond to a respective sleeve. The connector 81 can naturally be constructed as a sleeve, which corresponds with a corresponding connector. Comparably, in connector 83 for the optical fiber part 2 of the hybrid cable, some or all of the optical fibers are connected to individual connectors. In the construction shown, the connecting element 81, 83 are 8-fold connectors for copper cable or optical fibers, respectively. It is especially advantageous that the cable can be simply separated along the crosspiece 3, and then can be connectorized with the usual tools.

1. Hybrid cable with optical cores (121, 122) and electrical cores (221, 222) comprising:
a cable jacket with a first slot (14) enclosed all around and a second slot (24) enclosed all around, where the jacket parts (1, 2) forming the slots are connected to each other,
a first number of at least two optical cores (121, 122) arranged in the first slot (14), and
a second number of at least two electrical cores (221, 222) arranged in the second slot (24),
with a preferred bending axis (4) being formed, in which the optical cores (121, 122) and the electrical cores (221, 222) are essentially running:

2. Hybrid cable according to claim 1,
characterized by,
the first number of optical cores equaling the second number of electrical cores.

3. Hybrid cable according to claim 1 or 2,
characterized by,
the cable jacket (1, 2) having a symmetrical axis (4) running across the longitudinal direction, along which a crosspiece (3) connecting the two slots and the two slots (14, 24) extend, and within which the optical cores (121, 122) and the electrical cores (221, 222) are essentially contained.

4. Hybrid cable according to claim 2,
characterized by,
the diameter of the first slot running from the crosspiece (3) in the direction of the preferred bending axis (4) being smaller than the diameter of the second slot running in the direction of the preferred bending axis (4).

5. Hybrid cable according to one of the claims 1 to 4,
characterized by,
the optical cores (121, 122) being surrounded by tension relief elements (13) preferably made of aramid yams or Kevlar yams.

6. Hybrid cable according to claim 3 or 4,
characterized by,
the crosspiece (3) forming a point of separation for separating the first and second parts (1, 2) of the cable jacket.

7. Hybrid cable according to one of the claims 1 to 6,
characterized by,
the optical cores (121, 122) being bound together into a ribbon (12).

8. Hybrid cable according to one of the claims 1 to 7,
characterized by,
each of the electrical cores (221, 22) being metallic conductors, which are formed into a braided wire surrounded by a jacket (225) and the braided wire comprising metallic cores (223) stranded together.

9. Hybrid cable according to one of the claims 1 to 8,
characterized by,
the cable jacket (1, 2) being made of flame-retardant material.

10. Hybrid cable according to one of the claims 1 to 9,
characterized by,
the second number of electrical cores (221, 222) being wound by a polymer tape (61).

11. Hybrid cable according to one of the claims 1 to 10,
characterized by,
at least one of the parts (1, 2) of the cable jacket having an arch-like segment (113, 213) adjacent to the crosspiece (3), an arch-like segment (112, 212) away from the crosspiece, where the mentioned arch-like segments are connected to each other by straight segments (111, 211) running parallel to each other.

12. Hybrid cable arrangement, comprising a hybrid cable according to one of the claims 1 to 11 and a connective element (71), which is connected to one of the electrical cores (211) and one of the optical cores (121) in common.

13. Hybrid cable arrangement, comprising a hybrid cable according to one of the claims 1 to 11 and a first and second connecting element (81, 83), where the first connecting element (81) is connected to one of the optical cores, and the second connecting element (83) to one of the electrical cores.

14. Hybrid cable arrangement according to claim 13,
where all of the optical cores are connected to the first connecting element (81) and all of the electrical cores to the second connecting element (83).
